(19) United States
(12) Patent Application Publication
(10) Pub. No.: US 2024/0072251 A1
(43) Pub. Date: Feb. 29, 2024

(54) POSITIVE ELECTRODE ACTIVE MATERIAL FOR AQUEOUS POTASSIUM ION BATTERY, AND AQUEOUS POTASSIUM ION SECONDARY BATTERY

(71) Applicant: TOYOTA JIDOSHA KABUSHIKI KAISHA, Toyota-shi (JP)

(72) Inventors: Shigeki Sato, Fujinomiya-shi (JP); Shogo Kihara, Susono-shi (JP); Hiroshi Suyama, Mishima-shi (JP)

(21) Appl. No.: 18/343,846

(22) Filed: Jun. 29, 2023

(30) Foreign Application Priority Data
Aug. 29, 2022 (JP) 2022-136000

(51) Int. Cl. H01M 4/505; C01G 45/12; H01M 10/26

(52) U.S. Cl. CPC H01M 4/505; C01G 45/1214; H01M 10/26; H01M 2004/028

(57) ABSTRACT

The disclosure provides a novel positive electrode active material for an aqueous potassium ion battery, and a novel potassium ion secondary battery. The positive electrode active material for an aqueous potassium ion battery is represented by the general formula LiₓMn₂O₄, where 0<x<2. The aqueous potassium ion secondary battery comprises a positive electrode active material represented by the general formula LiₓMn₂O₄ where 0<x<2, and an aqueous electrolyte solution, wherein the aqueous electrolyte solution has a pH of 7.0 to 13.0 and comprises an aqueous solvent and a potassium salt dissolved in the aqueous solvent. The potassium salt is preferably potassium pyrophosphate.

### FIELD

The present disclosure relates to a positive electrode active material for an aqueous potassium ion battery, and to an aqueous potassium ion secondary battery.

### BACKGROUND

PTL 1 discloses an aqueous electrolyte solution containing water and potassium pyrophosphate dissolved in water, as an electrolyte solution to be used in an aqueous potassium ion battery.

### CITATION LIST

### Patent Literature

[PTL 1] Japanese Unexamined Patent Publication No. 2019-220294

### SUMMARY

### Technical Problem

The cyanogen-based compound known as “Prussian blue”, for example, has been used as a positive electrode active material for potassium ion secondary batteries. Cyanogen-based compounds for positive electrode active materials sometimes generate cyanide when the battery malfunctions, while their energy density is also inadequate due to their large molecular structure.

It is an object of the present disclosure to provide a novel positive electrode active material for an aqueous potassium ion battery, and a novel potassium ion secondary battery.

### Solution to Problem

The present inventors have found that the aforementioned object can be achieved by the following means:

### <Aspect 1>

A positive electrode active material for an aqueous potassium ion battery which is represented by the general formula LiₓMn₂O₄, where 0<x<2.

### <Aspect 2>

An aqueous potassium ion secondary battery
comprising a positive electrode active material represented by the general formula LiₓMn₂O₄ where 0<x<2, and an aqueous electrolyte solution,
wherein the aqueous electrolyte solution has a pH of 7.0 to 13.0 and comprises an aqueous solvent and a potassium salt dissolved in the aqueous solvent.

### <Aspect 3>

The aqueous potassium ion secondary battery according to aspect 2, wherein the potassium salt is potassium pyrophosphate.

### <Aspect 4>

The aqueous potassium ion secondary battery according to aspect 3, wherein the potassium pyrophosphate is dissolved in the aqueous solvent at a concentration of 2.0 mol/kg or greater.

### <Aspect 5>

The aqueous potassium ion secondary battery according to aspect 4, wherein the potassium pyrophosphate is dissolved in the aqueous solvent at a concentration of 5.0 mol/kg or greater.

### Advantageous Effects of Invention

According to the disclosure it is possible to provide a novel positive electrode active material for an aqueous potassium ion battery, and a novel potassium ion secondary battery.

### BRIEF DESCRIPTION OF DRAWINGS

FIG. 1 is a schematic view showing a potassium ion secondary battery according to one embodiment of the disclosure.

FIG. 2 is a graph showing a charge-discharge curve for the evaluation cell of Example 1.

FIG. 3 is a graph showing a charge-discharge curve for the evaluation cell of Comparative Example 1.

FIG. 4 is a graph showing a charge-discharge curve for the evaluation cell of Comparative Example 2.

FIG. 5 is a graph showing a charge-discharge curve for the evaluation cell of Comparative Example 3.

FIG. 6 is a graph showing the relationship between potassium pyrophosphate concentration and ionic conductance.

FIG. 7 is a graph showing the relationship between potassium pyrophosphate concentration and pH.

### DESCRIPTION OF EMBODIMENTS

Embodiments of the disclosure will now be described in detail. The disclosure is not limited to the embodiments described below, however, and various modifications may be implemented which do not depart from the gist thereof.

### 1. Positive Electrode Active Material for Aqueous Potassium Ion Battery

The positive electrode active material for an aqueous potassium ion battery of the present disclosure (hereunder referred to as “positive electrode active material of the disclosure”) is represented by general formula LiₓMn₂O₄, where 0<x<2. In the formula, x is preferably 1.

The form of the positive electrode active material of the disclosure may be any common form used as a positive electrode active material for a battery. The positive electrode active material of the disclosure may be particulate, for example. In this case the particle diameters are not particularly restricted and may be selected as appropriate for the battery design.

The primary particle size of the positive electrode active material of the disclosure may be 1 nm or larger, 5 nm or larger, 10 nm or larger or 50 nm or larger, and 500 μm or smaller, 100 μm or smaller, 50 μm or smaller, 30 μm or smaller or 10 μm or smaller. The positive electrode active material of the disclosure may also have primary particles aggregated to form secondary particles. The particle diameters of the secondary particles in this case are not particularly restricted and may be 100 nm or larger, 500 nm or larger or 1 μm or larger, and 1000 μm or smaller, 500 μm or smaller, 100 μm or smaller, 50 μm or smaller, 30 μm or smaller or 20 μm or smaller, for example.

No positive electrode active material has been known in the prior art that can undergo charge-discharge in a potassium compound-dissolved electrolyte solution using both nonaqueous and aqueous systems.

One aspect of the present disclosure provides a novel material as a positive electrode active material for an aqueous potassium ion secondary battery. That is, according to the disclosure, a use was discovered for compounds represented by general formula LiₓMn₂O₄ where 0<x<2, as positive electrode active materials for an aqueous potassium ion battery, and especially an aqueous potassium ion secondary battery.

### 2. Aqueous Potassium Ion Secondary Battery

The aqueous potassium ion secondary battery of the disclosure comprises a positive electrode active material of the disclosure and an aqueous electrolyte solution, where the aqueous electrolyte solution has a pH of 7.0 to 13.0 and comprises an aqueous solvent and a potassium salt dissolved in the aqueous solvent.

As mentioned above under “1. Positive electrode active material for an aqueous potassium ion battery”, no positive electrode active material has been known that can undergo charge-discharge in a potassium compound-dissolved electrolyte solution. Notably, optimal combinations of electrolyte solutions and positive electrode active materials for allowing charge-discharge constitute only a very small portion of the infinite possible combinations of electrolyte solutions and positive electrode active materials, and charge-discharge can become impossible with even slight changes in the crystal structures of active materials or the components and potential windows of electrolyte solutions. In other words, an optimal combination cannot be discovered without evaluating actual combinations of electrolyte solutions and positive electrode active materials.

The technology of the present disclosure was obtained by discovering novel combinations that allow charge-discharge, through repeated trial and error from among the infinite possible combinations of electrolyte solutions and positive electrode active materials, and it could not have been easily devised from the prior art.

### 2-1. Aqueous Electrolyte Solution

The aqueous electrolyte solution of the potassium ion secondary battery of the disclosure has a pH of 7.0 to 13.0 and comprises an aqueous solvent and a potassium salt dissolved in the aqueous solvent.

The pH of the aqueous electrolyte solution may be 7.0 or higher, 8.0 or higher, 9.0 or higher or 10.0 or higher, and 13.0 or lower, 12.5 or lower, 12.0 or lower or 11.5 or lower.

### 2-1-1. Aqueous Solvent

The aqueous solvent used in the potassium ion secondary battery of the disclosure is a water-containing solvent. The aqueous solvent may include water as the major component. Specifically, water may constitute 50 mol % or greater, 70 mol % or greater, 90 mol % or greater or 95 mol % or greater of the total amount (100 mol %) of aqueous solvent in the electrolyte solution. The upper limit for the proportion of water in the aqueous solvent is not particularly restricted, and the aqueous solvent may even contain 100 mol % water, i.e. the total amount may be water.

Although the aqueous solvent may consist entirely of water, it may also comprise other components such as one or more organic solvents selected from among ethers, carbonates, nitriles, alcohols, ketones, amines, amides, sulfur compounds and hydrocarbons. A solvent other than water may constitute up to 50 mol %, up to 30 mol %, up to 10 mol % or up to 5 mol % of the total amount (100 mol %) of the aqueous solvent in the electrolyte solution.

### 2-1-2. Potassium Salt

A potassium salt may be dissolved in the aqueous solvent as an electrolyte for the potassium ion secondary battery of the disclosure.

The potassium salt may be potassium pyrophosphate.

That the potassium pyrophosphate is “dissolved” in the solvent does not necessarily mean that it completely ionizes into potassium ion and pyrophosphate ion in the aqueous electrolyte solution. That is, the “dissolved potassium pyrophosphate” in the aqueous electrolyte solution may exist as ions such as K⁺, P₂O₇⁴⁻, KP₂O₇³⁻, K₂P₂O₇²⁻ and K₃P₂O₇⁻, or as associations of these ions. The “dissolved potassium pyrophosphate” in the aqueous electrolyte solution also does not necessarily need to be derived from potassium and pyrophosphoric acid salt (K₄P₂O₇) (that is, obtained by addition of K₄P₂O₇ to water). For example, solutions having the aforementioned ions or associated complexes in water as a result of separately adding and dissolving a potassium ion source (such as KOH or CH₃COOK) and a pyrophosphate ion source (such as H₄P₂O₇) in water, are also included for the aforementioned aqueous electrolyte solution.

The concentration of potassium pyrophosphate in the aqueous electrolyte solution is not particularly restricted and may be appropriately selected depending on the desired performance for the battery.

The potassium pyrophosphate may be dissolved in the aqueous solvent of the aqueous electrolyte solution to a concentration of 2.0 mol/kg or greater, i.e. 2.0 mol or greater per 1.0 kg of aqueous solvent, or at a concentration of 5.0 mol/kg or greater, i.e. 5.0 mol or greater per 1.0 kg of aqueous solvent.

A potassium pyrophosphate concentration of 2.0 mol/kg or greater in the aqueous electrolyte solution is preferred as it lowers overvoltage and tends to produce a more satisfactory charge-discharge plateau.

Based on new knowledge obtained by the present inventors, a higher potassium pyrophosphate concentration in the aqueous electrolyte solution lowers the hysteresis during charge-discharge of the positive electrode active material, tending to result in higher performance as a potassium ion secondary battery. A higher potassium pyrophosphate concentration in the aqueous electrolyte solution also lowers overvoltage and tends to result in a more satisfactory charge-discharge plateau. A higher potassium pyrophosphate concentration in the aqueous electrolyte solution is also thought to lead to easier formation of associated complexes by adjacent pyrophosphate ions and potassium ions. Therefore, during charge of a potassium ion secondary battery, presumably, pyrophosphate ions are more readily dragged toward potassium ions to migrate to the negative electrode side. Pyrophosphate ions that have reached the negative electrode degrade at the high work function sites on the negative electrode surface and are thought to thus form a coating on the negative electrode surface which inhibits direct contact between the aqueous electrolyte solution and the high work function sites on the negative electrode surface, tending to inhibit electrolysis of the aqueous electrolyte solution.

The concentration of the “dissolved potassium pyrophosphate” in the aqueous electrolyte solution can be determined as follows. For example, the elements and ions in the aqueous electrolyte solution can be determined by elemental analysis or ion analysis, allowing quantification of the potassium ion concentration and pyrophosphate ion concentration in the aqueous electrolyte solution, and the determined ion concentrations may then be converted to potassium pyrophosphate concentration. Alternatively, the solvent may be removed from the aqueous electrolyte solution and the solid content chemically analyzed and converted to potassium pyrophosphate concentration.

The total amount of potassium ion in the electrolyte of the aqueous electrolyte solution does not need to be converted to “dissolved potassium pyrophosphate”. In other words, potassium ion may be present in the aqueous electrolyte solution in a greater amount than the concentration that can be converted to potassium pyrophosphate. For example, when a potassium ion source other than a potassium pyrophosphate source (such as KOH, CH₃COOK or K₃PO₄) has been added and dissolved in water in addition to the potassium pyrophosphate source during production of the aqueous electrolyte solution, potassium ion will be present in the aqueous electrolyte solution at a greater concentration than can be converted to potassium pyrophosphate.

Cations other than potassium ion may also be included in the aqueous electrolyte solution. For example, alkali metal ions other than potassium ion, or alkaline earth metal ions or transition metal ions, may also be present. The aqueous electrolyte solution may further contain anions other than pyrophosphate ion (present as P₂O₇⁴⁻, or bound with cations, such as KP₂O₇³⁻, K₂P₂O₇²⁻ or K₃P₂O₇). Anions derived from the other electrolytes mentioned below may also be included.

The aqueous electrolyte solution of the disclosure may also have other electrolytes dissolved in it. For example, KPF₆, KBF₄, K₂SO₄, KNO₃, CH₃COOK, (CF₃SO₂)₂NK, KCF₃SO₃, (FSO₂)₂NK, K₂HPO₄ or KH₂PO₄ may be dissolved. Such other electrolytes may be present at 50 mol % or lower, 30 mol % or lower, 10 mol % or lower, 5 mol % or lower or 1 mol % or lower, based on the total amount (100 mol %) of the electrolytes dissolved in the electrolyte solution.

### 2-1-3. Other Components

In addition to aqueous solvents or electrolytes, the aqueous electrolyte solution may also include acids or hydroxides for pH adjustment of the aqueous electrolyte solution, as well as various other additives.

### 2-2. Remaining Construction

It is sufficient for the potassium ion secondary battery of the disclosure to have the positive electrode active material and aqueous electrolyte solution described above, while there are no particular restrictions on the rest of its construction. It is sufficient if the construction of the potassium ion secondary battery of the disclosure allows contact between the positive electrode active material and the aqueous electrolyte solution.

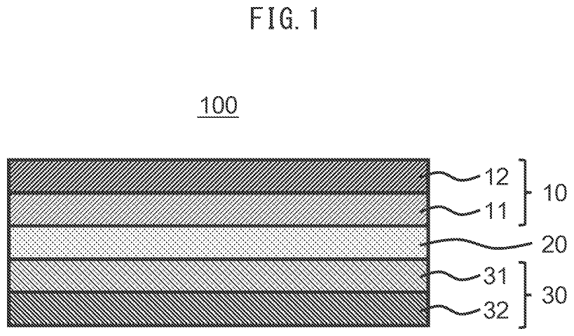

FIG. 1 schematically shows the construction of the potassium ion secondary battery 100 according to the first embodiment of the disclosure. As shown in FIG. 1, the potassium ion secondary battery 100 may comprise a positive electrode 10, an electrolyte layer 20 and a negative electrode 30. The positive electrode 10 may comprise a positive electrode active material layer 11 and a positive electrode collector 12, and the negative electrode 30 may comprise a negative electrode active material layer 31 and a negative electrode collector 32. In this case, the positive electrode active material layer 11 may include the aforementioned positive electrode active material. The positive electrode 10, electrolyte layer 20 and negative electrode 30 may all include the aqueous electrolyte solution.

### 2-2-1. Positive Electrode

The positive electrode may otherwise have a publicly known construction, so long as it includes the aforementioned positive electrode active material and aqueous electrolyte solution. For example, the positive electrode may comprise a positive electrode active material layer and a positive electrode collector.

### 2-2-1-1. Positive Electrode Active Material Layer

The positive electrode active material layer may include the aforementioned positive electrode active material, and optionally also a conductive aid and a binder. The thickness of the positive electrode active material layer is not particularly restricted, and may be 0.1 μm or greater or 1 μm or greater, and 1 mm or lower or 100 μm or lower, for example.

The amount of positive electrode active material in the positive electrode active material layer is not particularly restricted. For example, the positive electrode active material may be included at 20 mass % or greater, 40 mass % or greater, 60 mass % or greater or 70 mass % or greater, and 99 mass % or lower, 97 mass % or lower or 95 mass % or lower, based on the total amount (100 mass %) of the positive electrode active material layer.

The conductive aid optionally included in the positive electrode active material layer may be any of various publicly known conductive aids used in potassium ion secondary batteries. Carbon is one example of such a material. More specific examples include Ketchen black (KB), vapor-grown carbon fibers (VGCF), acetylene black (AB), carbon nanotubes (CNT), carbon nanofibers (CNF), carbon black, coke and graphite. Metal materials that can withstand the environment of battery use may also be used as alternatives. The conductive aid may be of a single type alone, or two or more different types may be used in combination. The form of the conductive aid may be any of various forms such as powdered or filamentous forms. The amount of conductive aid used in the positive electrode active material layer is not particularly restricted.

The binder optionally included in the positive electrode active material layer may be any of various publicly known binders used in potassium ion secondary batteries. Examples include styrene-butadiene rubber (SBR)-based binders, carboxymethyl cellulose (CMC)-based binders, acrylonitrile-butadiene rubber (ABR)-based binders, butadiene rubber (BR)-based binders, polyvinylidene fluoride (PVDF)-based binders and polytetrafluoroethylene (PTFE)-based binders. The binder may be of a single type alone, or two or more different types may be used in combination. The amount of binder used in the positive electrode active material layer is not particularly restricted.

### 2-2-1-2. Positive Electrode Collector

The positive electrode collector may be composed of a publicly known metal that is usable as a positive electrode collector for a potassium ion secondary battery. Examples of such metals include metal materials containing one or more elements selected from the group consisting of Cu, Ni, Al, V, Au, Pt, Mg, Fe, Ti, Pb, Co, Cr, Zn, Ge, In, Sn and Zr. The form of the positive electrode collector is not particularly restricted. Various forms such as foils, meshes and porous forms may be employed. There may also be used base materials having the aforementioned metals vapor deposited or plated on the surface.

### 2-2-2. Electrolyte Layer

The potassium ion secondary battery may also have an electrolyte layer disposed between the positive electrode active material layer and negative electrode active material layer. The electrolyte layer may be constructed of a separator and the aforementioned aqueous electrolyte solution. The separator used may be any publicly known separator commonly used in secondary batteries (such as a nickel-hydrogen batteries or zinc air batteries). For example, the separator may be one that is hydrophilic, such as a nonwoven fabric constructed from a cellulose material. The thickness of the separator is not particularly restricted and may be 5 m to 1 mm, for example.

### 2-2-3. Negative Electrode

The negative electrode may have a publicly known construction as a negative electrode for a potassium ion secondary battery. For example, the negative electrode may comprise a negative electrode active material layer and a negative electrode collector.

### 2-2-3-1. Negative Electrode Active Material Layer

The negative electrode active material layer includes a negative electrode active material. The negative electrode active material layer may also include a conductive aid or binder in addition to the negative electrode active material. The thickness of the negative electrode active material layer is not particularly restricted, and may be 0.1 μm or greater or 1 μm or greater, and 1 mm or lower or 100 μm or lower, for example.

The negative electrode active material in the negative electrode active material layer may be selected from among active materials with lower charge-discharge potential of carrier ions than the positive electrode active material, in consideration of the potential window of the aqueous electrolyte solution. Examples include potassium-transition metal complex oxides; titanium oxide; metal sulfides such as Mo₆S₈; simple sulfur; KTi₂(PO₄)₃; and NASICON-type compounds. The negative electrode active material may be of a single type alone, or two or more different types may be used in combination.

The form of the negative electrode active material is not particularly restricted and may be particulate, for example. In this case the particle diameters are not particularly restricted and may be selected as appropriate for the battery design.

The primary particle size of the negative electrode active material may be 1 nm or larger, 5 nm or larger, 10 nm or larger, 50 nm or larger or 100 nm or larger, and 500 μm or smaller, 100 μm or smaller, 50 μm or smaller, 30 μm or smaller or 10 μm or smaller. The negative electrode active material may also have primary particles aggregated to form secondary particles. The particle diameters of the secondary particles in this case are not particularly restricted and may be 100 nm or larger, 500 nm or larger or 1 μm or larger, and 1000 μm or smaller, 500 μm or smaller, 100 μm or smaller, 50 μm or smaller, 30 μm or smaller or 20 μm or smaller, for example.

The amount of negative electrode active material layer in the negative electrode active material layer is not particularly restricted. For example, the negative electrode active material may be included at 20 mass % or greater, 40 mass % or greater, 60 mass % or greater or 70 mass % or greater, and 99 mass % or lower, 97 mass % or lower or 95 mass % or lower, based on the total amount (100 mass %) of the negative electrode active material layer.

The type of conductive aid or binder optionally included in the negative electrode active material layer is not particularly restricted, and it may be appropriately selected from among the conductive aids and binders to be optionally included in the positive electrode active material layer, for example. The amount of conductive aid or binder used in the negative electrode active material layer is not particularly restricted.

### 2-2-3-2. Negative Electrode Collector

The negative electrode collector may be composed of a publicly known metal that is usable as a negative electrode collector for a potassium ion secondary battery. Examples of such metals include metal materials containing one or more elements selected from the group consisting of Cu, Ni, Al, V, Au, Pt, Mg, Fe, Ti, Pb, Co, Cr, Zn, Ge, In, Sn and Zr. From the viewpoint of stability in the aqueous electrolyte solution, the negative electrode collector may include one or more elements selected from the group consisting of Al, Ti, Pb, Zn, Sn, Mg, Zr and In, or it may include one or more elements selected from the group consisting of Ti, Pb, Zn, Sn, Mg, Zr and In, or it may include Ti. Al, Ti, Pb, Zn, Sn, Mg, Zr and In all have low work functions and are expected to be resistant to electrolysis in the aqueous electrolyte solution even after having contacted with the aqueous electrolyte solution.

The form of the negative electrode collector is not particularly restricted. Various forms such as foils, meshes or porous forms may be used. There may also be used base materials having the aforementioned metals plated or vapor deposited on the surface.

The negative electrode collector surface may also be coated with a carbon material. Specifically, the negative electrode may further comprise a negative electrode collector, and a coating layer formed on the surface of the negative electrode collector where the aqueous electrolyte solution is disposed (formed between the negative electrode collector and the negative electrode active material layer), the coating layer optionally including a carbon material. Carbon materials include Ketchen black (KB), vapor-grown carbon fibers (VGCF), acetylene black (AB), carbon nanotubes (CNT), carbon nanofibers (CNF), carbon black, coke and graphite.

The thickness of the coating layer is not particularly restricted. The coating layer may be formed over the entire surface of the negative electrode collector, or over only a portion thereof.

A binder may also be included in the coating layer, for binding between the carbon materials and between the carbon materials and the negative electrode collector.

The withstand voltage of the aqueous electrolyte solution on the reduction side can be more easily increased by providing a coating layer containing a carbon material on the negative electrode collector surface. Since the edge sections of the carbon material have high reactivity, they are more likely to have adsorption and decomposition of anions such as pyrophosphate ion in the aqueous electrolyte solution, and to accumulate a coating film. When an aqueous electrolyte solution is used in the potassium ion secondary battery, therefore, it is thought that the edge sections of the carbon material become inactivated, helping to inhibit electrolysis of the aqueous electrolyte solution at the edge sections, and widening the potential window of the aqueous electrolyte solution on the reduction side as a result.

In addition to this construction, the potassium ion secondary battery may also have other obvious construction members for a battery, such as terminals and a battery case.

The potassium ion secondary battery with such a construction can be produced by obtaining a positive electrode having a positive electrode active material layer formed on the positive electrode collector surface by either a wet or dry method, obtaining a negative electrode having a negative electrode active material layer formed on the negative electrode collector surface by either a wet or dry method, disposing a separator between the positive electrode and negative electrode, and impregnating them with the aqueous electrolyte solution.

### EXAMPLES

### Example 1 and Comparative Examples 1 to 3

### Example 1

### (Fabrication of Positive Electrode)

A positive electrode active material mixture was prepared by combining LiMn₂O₄ as a positive electrode active material, acetylene black as a conductive aid and PVDF and CMC as binders, in a mass ratio of 85:10:4.5:0.5. A doctor blade was used to evenly coat the positive electrode active material onto the surface of a Ni foil, which was then dried to obtain a positive electrode for evaluation. The positive electrode had a positive electrode active material layer comprising a positive electrode active material formed on the surface of the Ni foil serving as the positive electrode collector.

### (Fabrication of Evaluation Cell)

An evaluation cell was fabricated with the following structure.
Cell: VM5 (EC Frontier Co., Ltd.)
Working electrode: Positive electrode, open area 1 cm²
Counter electrode: Pt mesh
Reference electrode: Ag/AgCl
Aqueous electrolyte solution: 5.0 mol/kg potassium pyrophosphate (K₄P₂O₇) aqueous solution

### (Evaluation of Cell)

The charge-discharge characteristic of the evaluation cell was evaluated by charge-discharge under the following conditions.
Charge-discharge current value: 0.1 mA/cm²
Current application time: 10 hours
Cut voltage: 0.25 to 0.75 V vs. Ag/AgCl
Measuring temperature: 25° C.
Cycles: 20

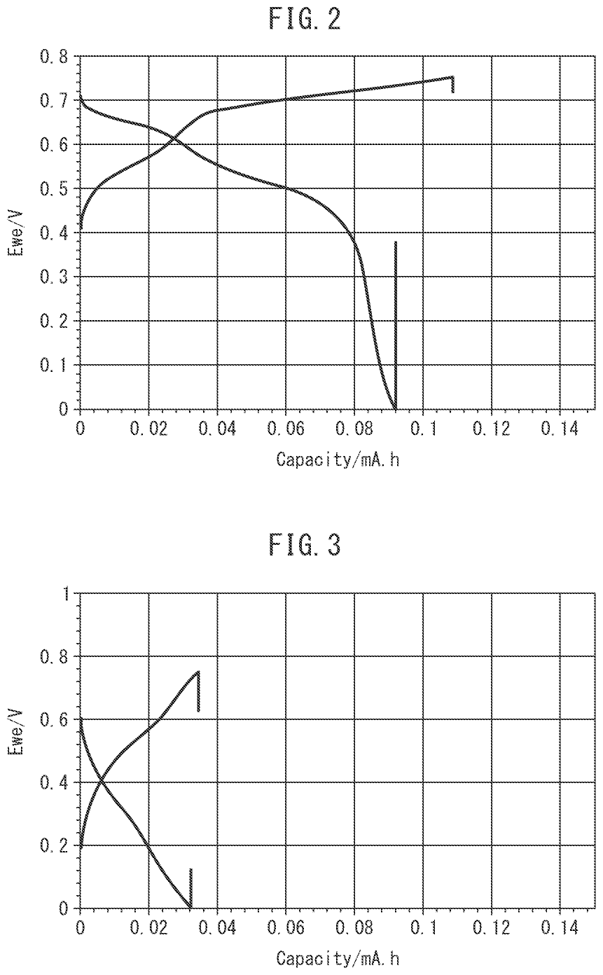

The evaluation results are shown in FIG. 2. FIG. 2 is a graph showing a charge-discharge curve for the evaluation cell of Example 1.

As shown in FIG. 2, it was confirmed that with LiMn₂O₄, electrochemical ion-exchange reaction of potassium ions was possible using a 5.0 mol/kg potassium pyrophosphate aqueous solution as the electrolyte solution.

### Comparative Example 1

An evaluation cell for Example 2 was fabricated and evaluated in the same manner as Example 1, except that LiNiO₂ was used as the positive electrode active material.

The evaluation results are shown in FIG. 3. FIG. 3 is a graph showing a charge-discharge curve for the evaluation cell of Comparative Example 1.

As shown in FIG. 3, LiNiO₂ exhibited no charge-discharge activity as a positive electrode active material for a potassium ion secondary battery.

### Comparative Example 2

An evaluation cell for Example 2 was fabricated and evaluated in the same manner as Example 1, except that LiNi_{0.5}Mn_{0.5}O₂ was used as the positive electrode active material.

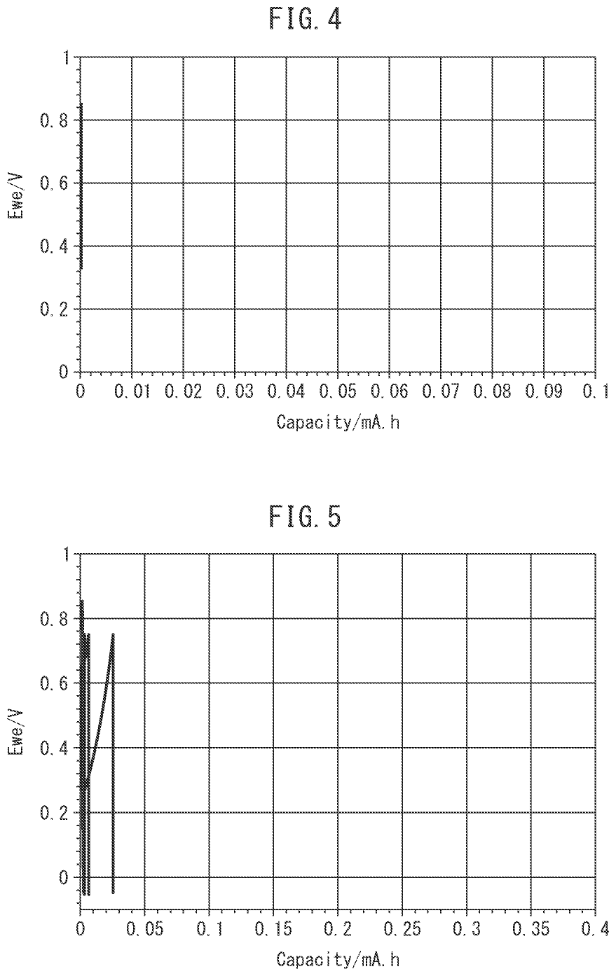

The evaluation results are shown in FIG. 4. FIG. 3 is a graph showing a charge-discharge curve for the evaluation cell of Comparative Example 2.

As shown in FIG. 4, LiNi_{0.5}Mn_{0.5}O₂ exhibited no charge-discharge activity as a positive electrode active material for a potassium ion secondary battery.

### Comparative Example 3

An evaluation cell for Example 2 was fabricated and evaluated in the same manner as Example 1, except that LiFePO₄ was used as the positive electrode active material.

The evaluation results are shown in FIG. 5. FIG. 5 is a graph showing a charge-discharge curve for the evaluation cell of Comparative Example 3.

As shown in FIG. 5, LiFePO₄ exhibited no charge-discharge activity as a positive electrode active material for a potassium ion secondary battery.

### Reference Examples 1 and 2

### Reference Example 1

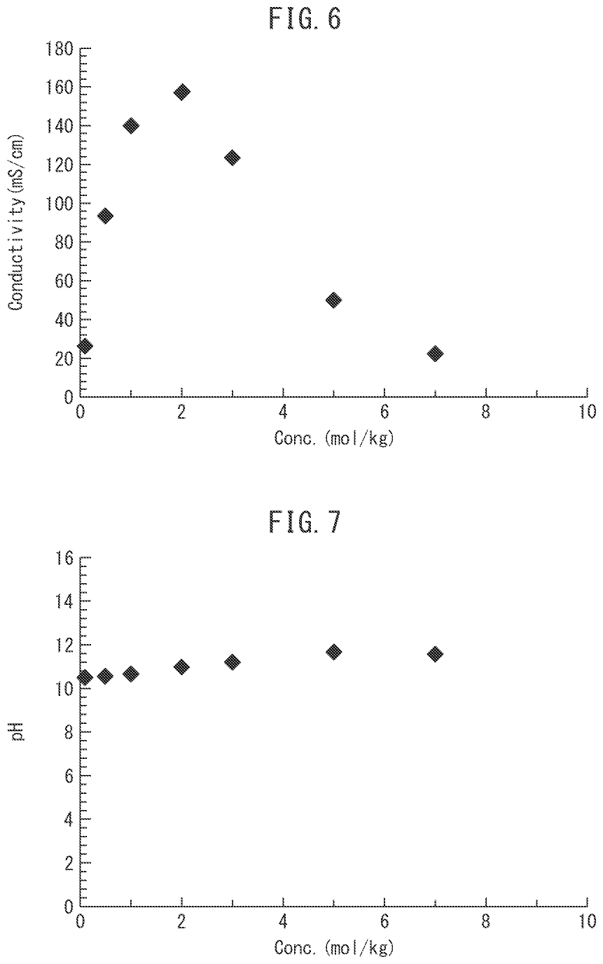

The relationship between potassium pyrophosphate concentration in the aqueous solution and potassium ion conductivity is shown in FIG. 6.

The potassium pyrophosphate aqueous solution exhibited potassium ion conductivity when the potassium pyrophosphate concentration was in the range of greater than 0 mol/kg and 8 mol/kg or lower in the potassium pyrophosphate solution.

### Reference Example 2

The relationship between potassium pyrophosphate concentration in the aqueous solution and pH is shown in FIG. 7.

The pH of the potassium pyrophosphate aqueous solution was 10.0 to 12.0 when the potassium pyrophosphate concentration was in the range of greater than 0 mol/kg and 8 mol/kg or lower in the potassium pyrophosphate solution.

### REFERENCE SIGNS LIST

10 Positive electrode
11 Positive electrode active material layer
12 Positive electrode collector
20 Electrolyte layer
30 Negative electrode
31 Negative electrode active material layer
32 Negative electrode collector
100 Potassium ion secondary battery

1. A positive electrode active material for an aqueous potassium ion battery, which is represented by the general formula LiₓMn₂O₄, where 0<x<2.

2. An aqueous potassium ion secondary battery comprising a positive electrode active material represented by the general formula LiₓMn₂O₄ where 0<x<2, and an aqueous electrolyte solution, wherein the aqueous electrolyte solution has a pH of 7.0 to 13.0 and comprises an aqueous solvent and a potassium salt dissolved in the aqueous solvent.

3. The aqueous potassium ion secondary battery according to claim 2, wherein the potassium salt is potassium pyrophosphate.

4. The aqueous potassium ion secondary battery according to claim 3, wherein the potassium pyrophosphate is dissolved in the aqueous solvent at a concentration of 2.0 mol/kg or greater.

5. The aqueous potassium ion secondary battery according to claim 4, wherein the potassium pyrophosphate is dissolved in the aqueous solvent at a concentration of 5.0 mol/kg or greater.
